(19) United States
(12) Patent Application Publication
(10) Pub. No.: US 2024/0381509 A1
(43) Pub. Date: Nov. 14, 2024

(54) ILLUMINATION DEVICE AND ILLUMINATION CONTROL SYSTEM

(71) Applicant: Japan Display Inc., Tokyo (JP)

(72) Inventors: Kazunori YAMAGUCHI, Tokyo (JP); Hiroyuki WAKANA, Tokyo (JP); Takayuki IMAI, Tokyo (JP)

(21) Appl. No.: 18/781,408

(22) Filed: Jul. 23, 2024

Related U.S. Application Data
(63) Continuation of application No. PCT/JP2022/047623, filed on Dec. 23, 2022.

(30) Foreign Application Priority Data
Jan. 26, 2022 (JP) 2022-010281

(51) Int. Cl. H05B 47/105; F21V 33/00; G02F 1/1347; G06F 1/16; H05B 47/175; H05B 47/19

(52) U.S. Cl. CPC H05B 47/105; F21V 33/0052; G02F 1/1347; H05B 47/19; H05B 47/1965; G06F 1/1643

(57) ABSTRACT

According to an aspect, an illumination device includes a light source, a light adjustment device configured to control a light distribution angle of light emitted from the light source, and a controller configured to control the light adjustment device. The controller includes a storage configured to hold correspondence information indicating a correspondence relation between first data that is input from a control device and second data that is used to control the light distribution angle, a data generator configured to generate second data by adjusting the first data based on the correspondence information, and a driver configured to drive the light adjustment device based on the second data.

### CROSS-REFERENCE TO RELATED APPLICATION

This application claims the benefit of priority from Japanese Patent Application No. 2022-010281 filed on Jan. 26, 2022 and International Patent Application No. PCT/JP2022/047623 filed on Dec. 23, 2022, the entire contents of which are incorporated herein by reference.

### BACKGROUND

### 1. Technical Field

What is disclosed herein relates to an illumination device and an illumination control system.

### 2. Description of the Related Art

In a conventional illumination instrument, a light source such as an LED is combined with a thin lens provided with a prism pattern, and the distance between the light source and the thin lens is changed to change a light distribution angle. For example, an illumination instrument is disclosed in which the front of a transparent light bulb is covered by a liquid crystal light adjustment element, and the transmittance of a liquid crystal layer is changed to switch between directly reaching light and scattering light.

For example, a region that is irradiated with light from an illumination device including a liquid crystal cell can be adjusted by driving the liquid crystal cell to control the distribution angle of the light. It is desirable to make it easier to adjust the irradiation area of light from the illumination device in such an aspect. The distribution angle of light from the illumination device in such an aspect can be remotely operated by a control device exemplified by a portable communication terminal device such as a smartphone or a tablet. However, when there is a difference that a user feels between a value controlled on the control device and a region actually irradiated with light from the illumination device, it is difficult to set the irradiation area of light as intended.

For the foregoing reasons, there is a need for an illumination device and an illumination control system capable of easily adjusting the irradiation area of light.

### SUMMARY

According to an aspect, an illumination device includes a light source, a light adjustment device configured to control a light distribution angle of light emitted from the light source, and a controller configured to control the light adjustment device. The controller includes a storage configured to hold correspondence information indicating a correspondence relation between first data that is input from a control device and second data that is used to control the light distribution angle, a data generator configured to generate second data by adjusting the first data based on the correspondence information, and a driver configured to drive the light adjustment device based on the second data.

According to an aspect, an illumination control system includes an illumination device and a control device, the illumination device being capable of controlling a light distribution angle of light emitted from a light source, the control device being configured to control the illumination device. The control device includes a touch sensor, a detector configured to extract a touch detection position on the touch sensor, and a first data generator configured to generate first data in accordance with the touch detection position. The illumination device includes a light adjustment device configured to control the light distribution angle, and a controller configured to control the light adjustment device. The controller includes a storage configured to hold correspondence information indicating a correspondence relation between the first data and second data that is used to control the light distribution angle, a second data generator configured to generate second data by adjusting the first data based on the correspondence information, and a driver configured to drive the light adjustment device based on the second data.

According to an aspect, an illumination control system includes an illumination device and a control device, the illumination device being capable of controlling a light distribution angle of light emitted from a light source, the control device being configured to control the illumination device. The control device includes a touch sensor, a detector configured to extract a touch detection position on the touch sensor, a first data generator configured to generate first data in accordance with the touch detection position, a storage configured to hold correspondence information indicating a correspondence relation between the first data and second data that is used to control the light distribution angle, and a second data generator configured to generate second data by adjusting the first data based on the correspondence information. The illumination device includes a light adjustment device configured to control the light distribution angle, and a controller configured to control the light adjustment device. The controller includes a driver configured to drive the light adjustment device based on the second data.

### BRIEF DESCRIPTION OF THE DRAWINGS

FIG. 1A is a side view illustrating an example of an illumination device according to an embodiment;

FIG. 1B is a perspective view illustrating an example of a light control device according to the embodiment;

FIG. 2 is a schematic plan view of a first substrate when viewed in a Dz direction;

FIG. 3 is a schematic plan view of a second substrate when viewed in the Dz direction;

FIG. 4 is a fluoroscopic diagram of a liquid crystal cell in which the first substrate and the second substrate are stacked in the Dz direction;

FIG. 5 is a sectional view along line A-A′ illustrated in FIG. 4;

FIG. 6A is a diagram illustrating a rubbing direction of an alignment film of the first substrate;

FIG. 6B is a diagram illustrating a rubbing direction of an alignment film of the second substrate;

FIG. 7 is a conceptual diagram for conceptually describing the distribution angle of light from the illumination device according to the embodiment;

FIG. 8 is a schematic diagram illustrating an example of the configuration of an illumination control system according to the embodiment;

FIG. 9 is an external view illustrating an example of a control device according to the embodiment;

FIG. 10 is a conceptual diagram illustrating an example of a touch detection region of a touch sensor;

FIG. 11 is a diagram illustrating an example of a control block configuration that adjusts first data to be transmitted to the illumination device in the control device according to a first embodiment;

FIG. 12 is a conceptual diagram illustrating an example of a method of adjusting the first data in the first embodiment;

FIG. 13A is a conceptual diagram illustrating a first display example of the control device according to the first embodiment for adjusting the first data;

FIG. 13B is a conceptual diagram illustrating a second display example of the control device according to the first embodiment for adjusting the first data;

FIG. 14 is a flowchart illustrating an example of first data generation processing by the control device according to the first embodiment;

FIG. 15 is a diagram illustrating an example of a control block configuration that controls the light adjustment device in the illumination device according to the first embodiment;

FIG. 16A is a line diagram illustrating a first example of a look-up table indicating a correspondence relation between the first data and second data;

FIG. 16B is a line diagram illustrating a second example of the look-up table indicating the correspondence relation between the first data and the second data;

FIG. 16C is a line diagram illustrating a third example of the look-up table indicating the correspondence relation between the first data and the second data;

FIG. 17 is a flowchart illustrating an example of light distribution angle control processing by the illumination device according to the first embodiment;

FIG. 18 is a schematic diagram illustrating the relation between the light distribution angle and the light irradiation area controlled by the illumination device according to a second embodiment;

FIG. 19 is a flowchart illustrating an example of light distribution angle control processing by the illumination device according to the second embodiment;

FIG. 20 is a diagram illustrating an example of a control block configuration that adjusts the second data to be transmitted to the illumination device in the control device according to a third embodiment; and

FIG. 21 is a diagram illustrating an example of a control block configuration that controls the light adjustment device in the illumination device according to the third embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

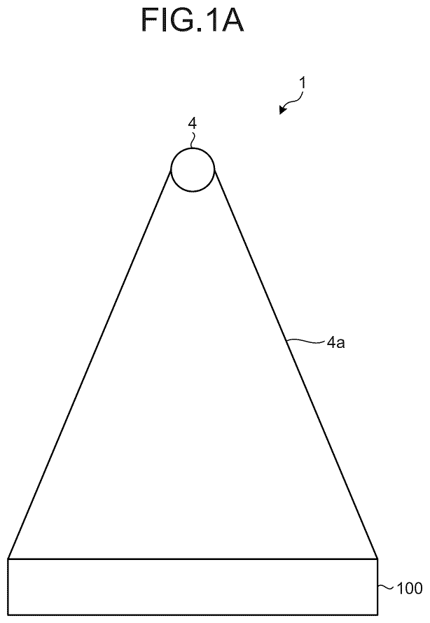

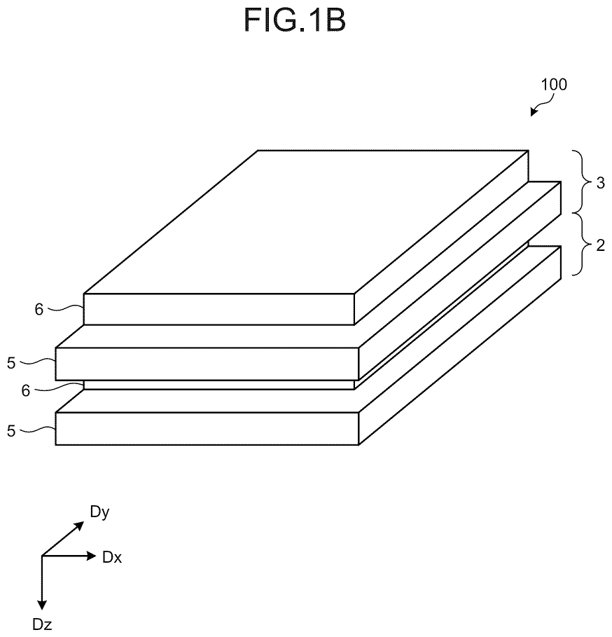

FIG. 1A is a side view illustrating an example of an illumination device according to an embodiment. FIG. 1B is a perspective view illustrating an example of a light control device according to the embodiment. As illustrated in FIG. 1A, an illumination device 1 includes a light source 4, a reflector 4a, and a light adjustment device 100. As illustrated in FIG. 1B, the light adjustment device 100 includes a first liquid crystal cell 2 and a second liquid crystal cell 3. The light source 4 includes, for example, a light emitting diode (LED). The reflector 4a is a component through which light from the light source 4 is condensed to the light adjustment device 100.

In FIG. 1B, a Dz direction represents the irradiation direction of light from the light source 4 and the reflector 4a. The light adjustment device 100 is formed by stacking the first liquid crystal cell 2 and the second liquid crystal cell 3 in the Dz direction. In FIG. 1, one direction in a plane parallel to a stacking plane of the first liquid crystal cell 2 and the second liquid crystal cell 3 orthogonal to the Dz direction is defined as a Dx direction, and a direction orthogonal to the Dx direction and the Dz direction is defined as a Dy direction.

The first liquid crystal cell 2 and the second liquid crystal cell 3 have the same configuration. In the present embodiment, the first liquid crystal cell 2 is a liquid crystal cell for p wave polarization. The second liquid crystal cell 3 is a liquid crystal cell for s wave polarization. Alternatively, the first liquid crystal cell 2 may be a liquid crystal cell for s wave polarization, and the second liquid crystal cell 3 may be a liquid crystal cell for p wave polarization. It is only needed that one of the first liquid crystal cell 2 and the second liquid crystal cell 3 is a liquid crystal cell for p wave polarization and the other is a liquid crystal cell for s wave polarization.

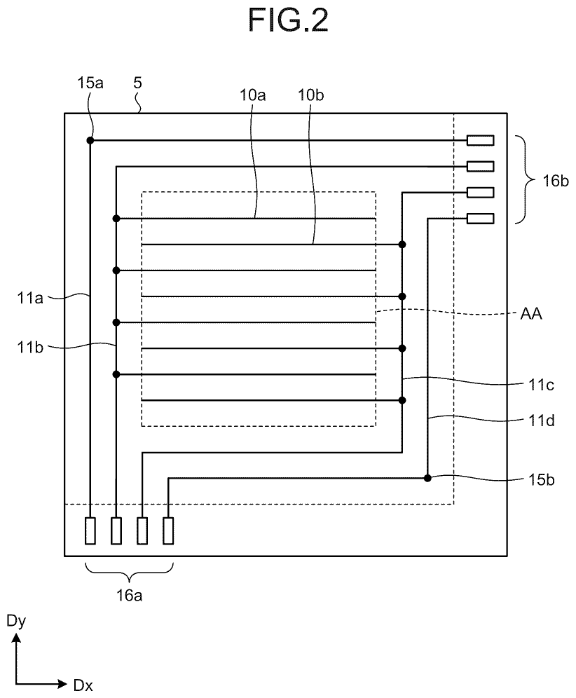

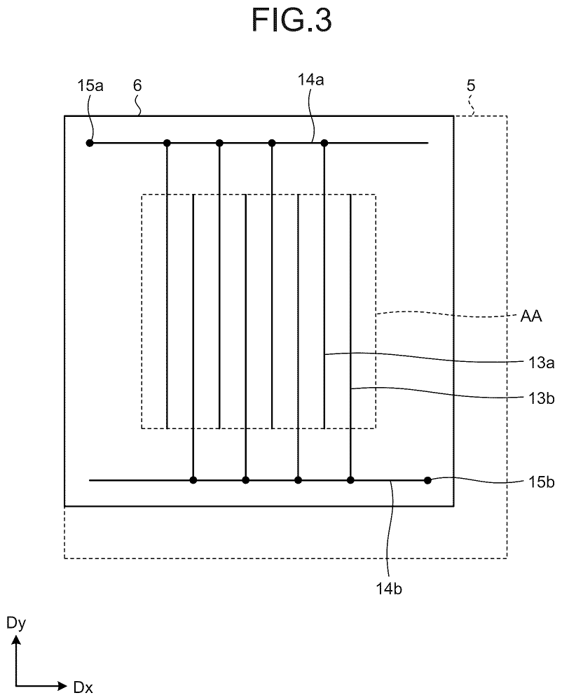

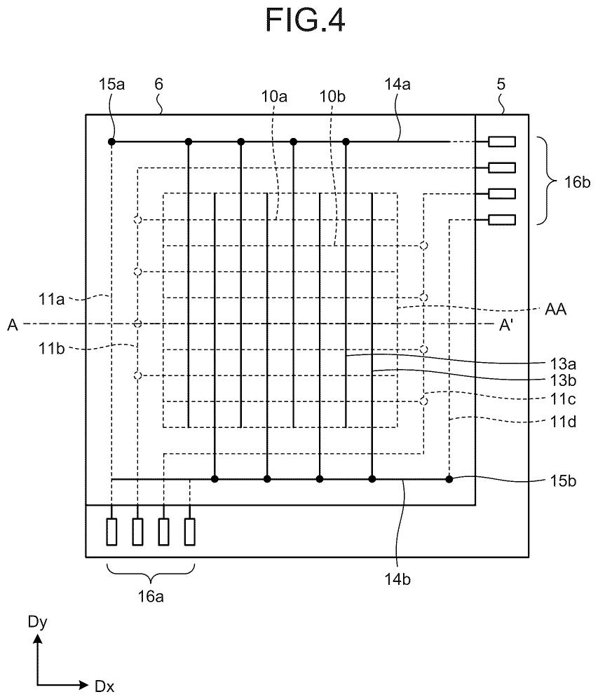

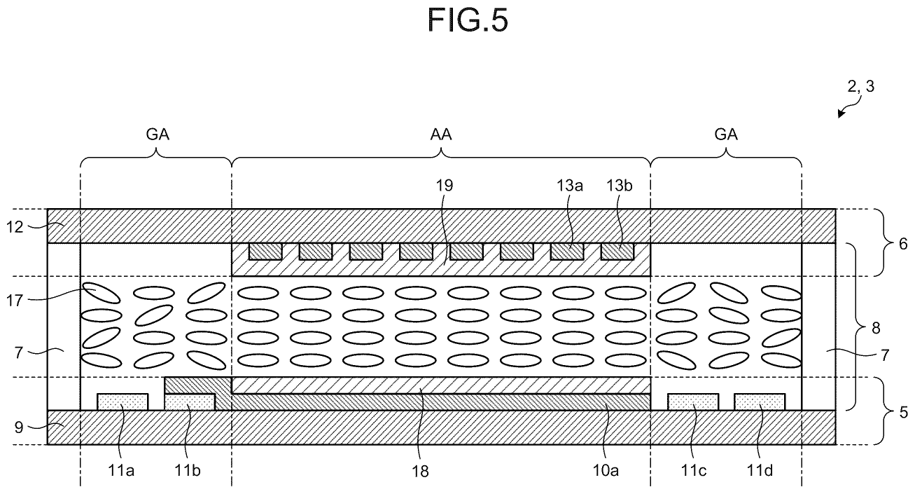

The first liquid crystal cell 2 and the second liquid crystal cell 3 each include a first substrate 5 and a second substrate 6. FIG. 2 is a schematic plan view of the first substrate when viewed in the Dz direction. FIG. 3 is a schematic plan view of the second substrate when viewed in the Dz direction. FIG. 4 is a fluoroscopic diagram of a liquid crystal cell in which the first substrate and the second substrate are stacked in the Dz direction. FIG. 5 is a sectional view along line A-A′ illustrated in FIG. 4.

As illustrated in FIG. 5, the first liquid crystal cell 2 and the second liquid crystal cell 3 each include a liquid crystal layer 8 between the first substrate 5 and the second substrate 6, and the liquid crystal layer 8 has a periphery sealed by a sealing member 7.

The liquid crystal layer 8 modulates light passing through the liquid crystal layer 8 in accordance with the state of electric field. The liquid crystal layer 8 may be, for example, of a horizontal electric field mode such as fringe field switching (FFS), which is a form of in-plane switching (IPS), or may be of a vertical electric field mode. Liquid crystal of various modes such as twisted nematic (TN), vertical alignment (VA), and electrically controlled birefringence (ECB) may be used, and the present disclosure is not limited by the kind and configuration of the liquid crystal layer 8.

As illustrated in FIG. 2, a plurality of drive electrodes 10a and 10b, a plurality of metal lines 11a and 11b, and a plurality of metal lines 11c and 11d are provided on the liquid crystal layer 8 side of a base member 9 of the first substrate 5 illustrated in FIG. 5. The metal lines 11a and 11b supply drive voltage to the drive electrodes 10 (drive electrodes 10a and 10b), and the metal lines 11c and 11d supply drive voltage to a plurality of drive electrodes 13a and 13b (refer to FIG. 3) provided at the second substrate 6 to be described later. The metal lines 11a, 11b, 11c, and 11d are provided in a wiring layer of the first substrate 5. The metal lines 11a, 11b, 11c, and 11d are provided at intervals in the wiring layer on the first substrate 5. Hereinafter, the drive electrodes 10a and 10b are simply referred to as “drive electrodes 10” in some cases. In addition, the metal lines 11a, 11b, 11c, and 11d are referred to as “first metal lines 11” in some cases. As illustrated in FIG. 2, the drive electrodes 10 on the first substrate 5 extend in the Dx direction.

As illustrated in FIG. 3, the drive electrodes 13a and 13b and a plurality of metal lines 14a and 14b are provided on the liquid crystal layer 8 side of a base member 12 of the second substrate 6 illustrated in FIG. 5. The metal lines 14a and 14b supply drive voltage to the drive electrodes 13 (drive electrodes 13a and 13b). The metal lines 14a and 14b are provided in a wiring layer of the second substrate 6. The metal lines 14a and 14b are provided at intervals in the wiring layer on the second substrate 6. Hereinafter, the drive electrodes 13a and 13b are simply referred to as “drive electrodes 13” in some cases. In addition, the metal lines 14a and 14b are referred to as “second metals line 14” in some cases. As illustrated in FIG. 3, the drive electrodes 13 on the second substrate 6 extend in the Dy direction.

The drive electrodes 10 and 13 are light-transmitting electrodes formed of a light-transmitting conductive material (light-transmitting conductive oxide) such as indium tin oxide (ITO). The first substrate 5 and the second substrate 6 are light-transmitting substrates of glass, resin, or the like. The first metal lines 11 and the second metal lines 14 are formed of at least one metallic material among aluminum (Al), copper (Cu), silver (Ag), molybdenum (Mo), and alloy thereof. The first metal lines 11 and the second metal lines 14 may be each formed of one or more of these metallic materials as a multilayered body of a plurality of layers. The at least one metallic material among aluminum (Al), copper (Cu), silver (Ag), molybdenum (Mo), and alloy thereof has a resistance lower than that of light-transmitting conductive oxide such as ITO.

The metal line 11a of the first substrate 5 and the metal line 14a of the second substrate 6 are coupled to each other through a conduction part 15a such as a via. The metal line 11d of the first substrate 5 and the metal line 14b of the second substrate 6 are coupled to each other through a conduction part 15b such as a via.

Coupling (Flex-on-Board) terminal parts 16a and 16b coupled to non-illustrated flexible printed circuits (FPC) are provided in a region on the first substrate 5, which does not overlap the second substrate 6 when viewed in the Dz direction. The coupling terminal parts 16a and 16b each include four coupling terminals corresponding to the metal lines 11a, 11b, 11c, and 11d.

The coupling terminal parts 16a and 16b are provided in the wiring layer of the first substrate 5. Drive voltage that is applied to the drive electrodes 10a and 10b on the first substrate 5 and the drive electrodes 13a and 13b on the second substrate 6 is supplied to the first liquid crystal cell 2 and the second liquid crystal cell 3 from the FPC coupled to the coupling terminal part 16a or 16b. Hereinafter, the coupling terminal parts 16a and 16b are simply referred to as “coupling terminal parts 16” in some cases.

As illustrated in FIG. 4, in the first liquid crystal cell 2 and the second liquid crystal cell 3, the first substrate 5 and the second substrate 6 are stacked in the Dz direction (light irradiation direction), and the drive electrodes 10 on the first substrate 5 intersect the drive electrodes 13 on the second substrate 6 when viewed in the Dz direction. In the first liquid crystal cell 2 and the second liquid crystal cell 3 thus configured, the orientation direction of liquid crystal molecules 17 in the liquid crystal layer 8 can be controlled by supplying drive voltage to each of the drive electrodes 10 on the first substrate 5 and the drive electrodes 13 on the second substrate 6. A region in which the orientation direction of the liquid crystal molecules 17 in the liquid crystal layer 8 can be controlled is referred to as a “light control region AA”. The refractive index distribution of the liquid crystal layer 8 in the light control region AA is changed, whereby light transmitted through the light control region AA of each of the first liquid crystal cell 2 and the second liquid crystal cell 3 can be controlled. A region outside the light control region AA where the liquid crystal layer 8 is sealed by the sealing member 7 is referred to as a “peripheral region GA” (refer to FIG. 5).

As illustrated in FIG. 5, the drive electrodes 10 (in FIG. 5, the drive electrode 10a) are covered by an alignment film 18 in the light control region AA of the first substrate 5. In addition, the drive electrodes 13 (in FIG. 5, the drive electrodes 13a and 13b) are covered by an alignment film 19 in the light control region AA of the second substrate 6. The alignment film 18 and the alignment film 19 have different rubbing directions.

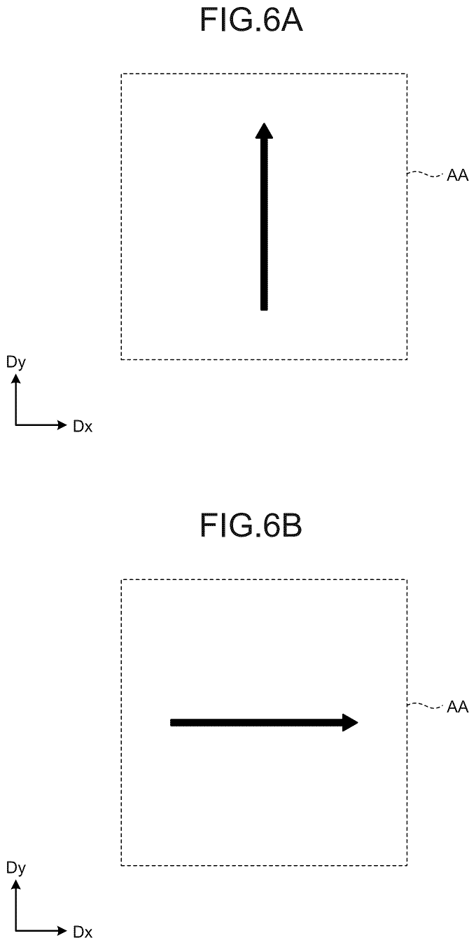

FIG. 6A is a diagram illustrating the rubbing direction of the alignment film of the first substrate 5. FIG. 6B is a diagram illustrating the rubbing direction of the alignment film of the second substrate 6.

As illustrated in FIGS. 6A and 6B, the rubbing direction of the alignment film 18 of the first substrate 5 and the rubbing direction of the alignment film 19 of the second substrate 6 are directions intersecting each other in a plan view. Specifically, the rubbing direction of the alignment film 18 of the first substrate 5 illustrated in FIG. 6A is orthogonal to the extension direction of the drive electrodes 10a and 10b. The rubbing direction of the alignment film 19 of the second substrate 6 illustrated in FIG. 6B is orthogonal to the extension direction of the drive electrodes 13a and 13b.

The present embodiment describes the configuration in which one first liquid crystal cell 2 and one second liquid crystal cell 3 are stacked, but is not limited to this configuration, and for example, a configuration including a plurality of combinations obtained by stacking the first liquid crystal cell 2 and the second liquid crystal cell 3 is also applicable. For example, a configuration including two combinations each of which is obtained by stacking the first liquid crystal cell 2 and the second liquid crystal cell 3, in other words, a configuration including two liquid crystal cells for p wave polarization and two liquid crystal cells for s wave polarization is applicable.

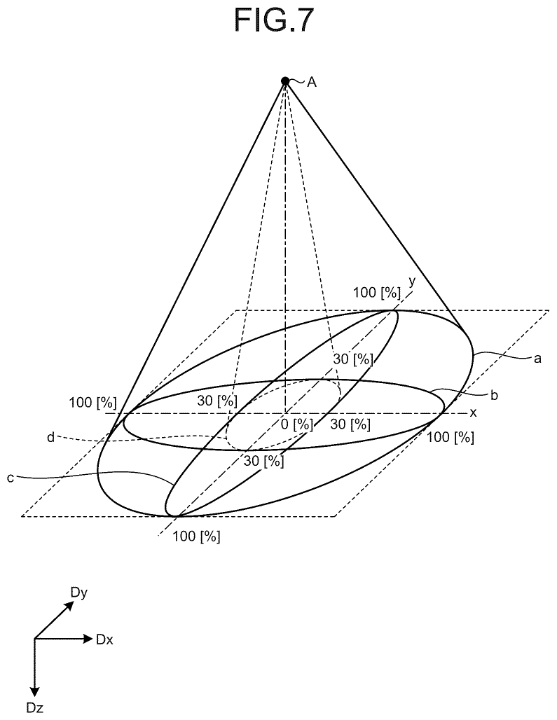

In the present disclosure, the distribution angle of light emitted from the light source 4 is controlled through drive voltage control of the first liquid crystal cell 2 and the second liquid crystal cell 3 in the illumination device 1 having the above-described configuration. The following describes the distribution angle of light from the illumination device 1, which is a control target in the present disclosure, with reference to FIG. 7.

FIG. 7 is a conceptual diagram for conceptually describing the distribution angle of light from the illumination device according to the embodiment. In FIG. 7, the illumination device 1 is assumed to be a point light source A, and the irradiation area of light on an imaginary plane xy orthogonal to the Dz direction is illustrated. Although FIG. 7 illustrates the example in which the illumination device 1 is assumed to be the point light source A, light that is transmitted through the light control region AA of each of the first liquid crystal cell 2 and the second liquid crystal cell 3 is controlled as described above in reality, and thus the illuminance of light decreases around the irradiation area. Furthermore, the outline of the irradiation area is indistinct due to light diffraction phenomenon and the like.

As described above, in each of the first liquid crystal cell 2 and the second liquid crystal cell 3, the orientation direction of the liquid crystal molecules 17 in the liquid crystal layer 8 is controlled by supplying drive voltage to each of the drive electrodes 10 on the first substrate 5 and the drive electrodes 13 on the second substrate 6. Thus, the distribution angle of light that is emitted from the illumination device 1 can be controlled.

Specifically, for example, the orientation direction of the liquid crystal molecules 17 in the liquid crystal layer 8 of the first liquid crystal cell 2 changes in accordance with the drive voltage applied to the drive electrodes 10 and 13 of the first liquid crystal cell 2, whereby the distribution angle in the Dx direction changes. In the present disclosure, the minimum distribution angle in the Dx direction is 0% and the maximum distribution angle in the Dx direction is 100%.

For example, the orientation direction of the liquid crystal molecules 17 in the liquid crystal layer 8 of the second liquid crystal cell 3 changes and the distribution angle in the Dy direction changes in accordance with drive voltage applied to the drive electrodes 10 and 13 of the second liquid crystal cell 3. In the present disclosure, the minimum distribution angle in the Dy direction is 0% and the maximum distribution angle in the Dy direction is 100%.

In FIG. 7, “a” exemplarily illustrates the irradiation area in a case where the distribution angle in the Dx direction and the distribution angle in the Dy direction are both 100%. In FIG. 7, “b” exemplarily illustrates the irradiation area in a case where the distribution angle in the Dx direction is 100% and the distribution angle in the Dy direction is 30%. In FIG. 7, “c” exemplarily illustrates the irradiation area in a case where the distribution angle in the Dx direction is 30% and the distribution angle in the Dy direction is 100%. In FIG. 7, “d” exemplarily illustrates the irradiation area in a case where the distribution angle in the Dx direction and the distribution angle in the Dy direction are both 30%.

In this manner, the distribution angle of light in the Dx and Dy directions can be controlled by performing drive voltage control of each of the first liquid crystal cell 2 and the second liquid crystal cell 3 in the illumination device 1 having the above-described configuration. Thus, the irradiation area of light from the illumination device 1 can be changed.

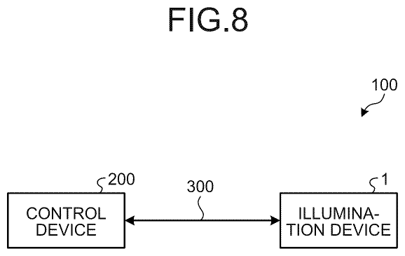

FIG. 8 is a schematic diagram illustrating an example of the configuration of an illumination control system according to the embodiment. The illumination control system includes the illumination device 1 and a control device 200. The control device 200 is, for example, a portable communication terminal device such as a smartphone or a tablet.

Data and various command signals are transmitted and received between the illumination device 1 and the control device 200 through a communication means 300. In the present disclosure, the communication means 300 is a wireless communication means such as Bluetooth (registered trademark) or WiFi (registered trademark). Wireless communication may be performed between the illumination device 1 and the control device 200 through a predetermined network such as a mobile communication network. Alternatively, the illumination device 1 and the control device 200 may be coupled to each other in a wired manner to perform wired communication therebetween.

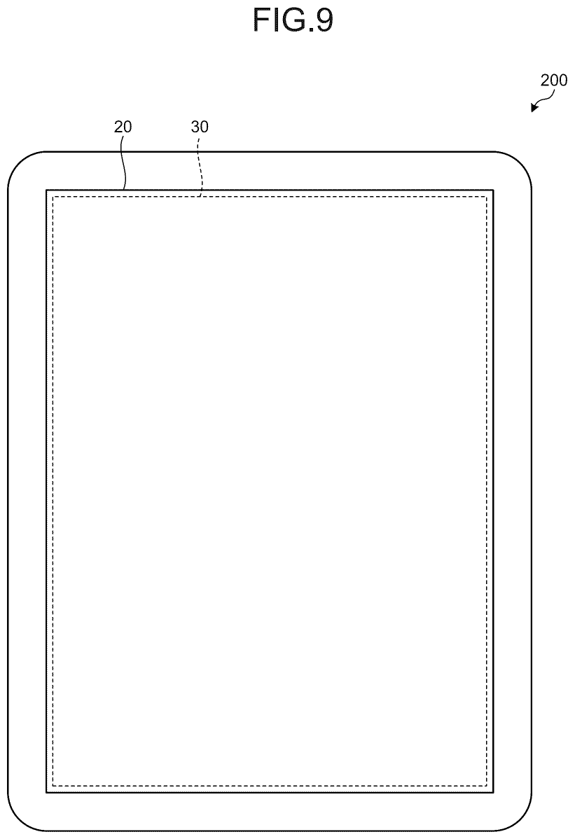

FIG. 9 is an external view illustrating an example of the control device according to the embodiment. The control device 200 is a display device equipped with a touch detection function, in which a display panel 20 and a touch sensor 30 are integrated. Specifically, the display panel 20 is what is called an in-cell type or hybrid type device in which the touch sensor 30 is built and integrated. The configuration in which the touch sensor 30 is built and integrated in the display panel 20 includes, for example, a configuration in which some components such as substrates and electrodes are used as both components of the display panel 20 and components of the touch sensor 30. The display panel 20 may be what is called an on-cell type device in which the touch sensor 30 is mounted on a display device.

The display panel 20 is, for example, a liquid crystal display panel including a liquid crystal display element. The display panel 20 is not limited thereto but may be, for example, an organic EL display panel (OLED: organic light emitting diode) or an inorganic EL display panel (micro LED or mini LED).

The touch sensor 30 is, for example, a capacitive touch sensor. The touch sensor 30 is not limited thereto but may be, for example, a touch sensor of a resistance film type, a touch sensor of an ultrasonic wave type, or a touch sensor of an optical type.

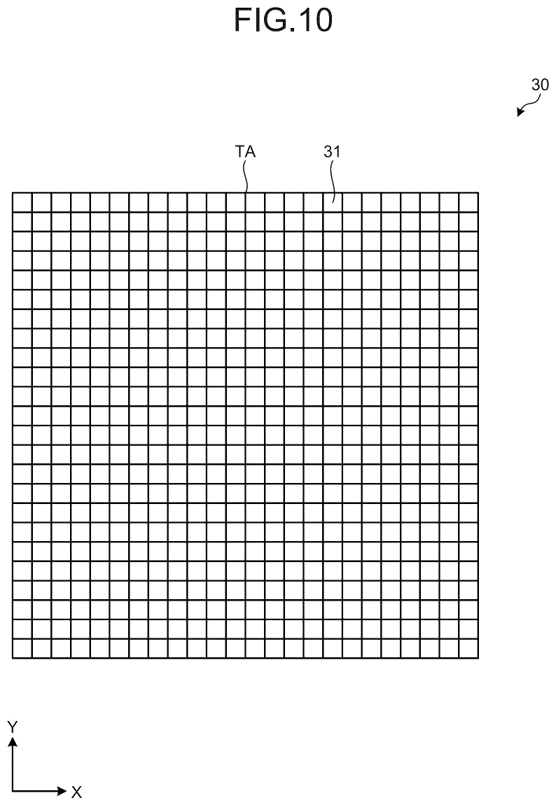

FIG. 10 is a conceptual diagram illustrating an example of a touch detection region of the touch sensor. A plurality of detection elements 31 are provided in a detection region FA of the touch sensor 30. In the detection region FA of the touch sensor 30, the detection elements 31 are arranged in an X direction (first direction) and a Y direction (second direction) orthogonal to the X direction and provided in a matrix of rows and columns. In other words, the touch sensor 30 includes the detection region FA overlapping the detection elements 31 arranged in the X direction (first direction) and the Y direction (second direction).

### First Embodiment

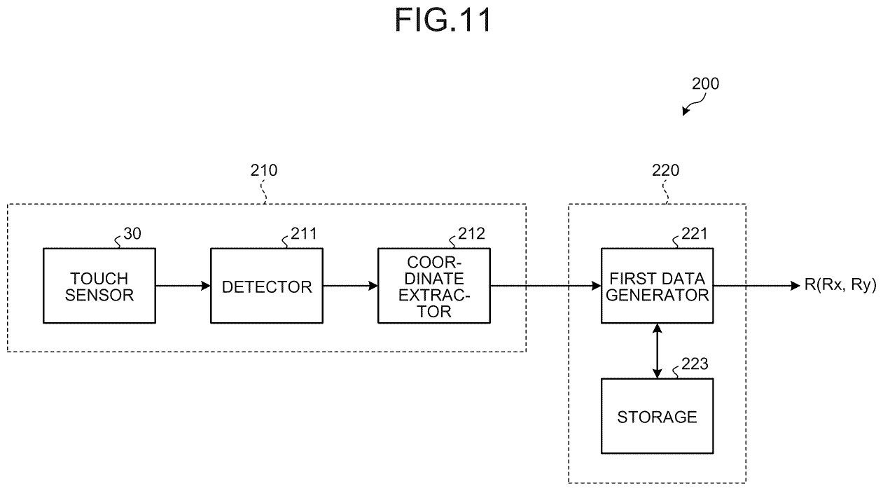

FIG. 11 is a diagram illustrating an example of a control block configuration that adjusts first data to be transmitted to the illumination device in the control device according to a first embodiment.

As illustrated in FIG. 11, the control device 200 according to the embodiment includes a detection device 210 and a processing device 220. The detection device 210 includes the touch sensor 30, a detector 211, and a coordinate extractor 212. The processing device 220 includes a first data generator 221 and a storage 223. The detector 211 and the coordinate extractor 212 of the detection device 210 are each constituted by, for example, a detection IC. The processing device 220 includes, for example, a central processing unit (CPU), a random access memory (RAM), an electrically erasable programmable read only memory (EEPROM), and a read only memory (ROM) of the smartphone, the tablet, or the like as the control device 200.

The detector 211 is a circuit configured to detect existence of a touch on or above the touch sensor 30 based on a detection signal output from each detection element 31 of the touch sensor 30.

The coordinate extractor 212 is a logic circuit configured to calculate the coordinates of a touch detection position when a touch is detected by the detector 211.

The first data generator 221 generates the first data in the X direction and the first data in the Y direction based on the touch detection position extracted by the coordinate extractor 212. The first data generator 221 is a component implemented by, for example, the CPU of the smartphone, the tablet, or the like as the control device 200.

The storage 223 is composed of, for example, the RAM, EEPROM, or ROM of the smartphone, the tablet, or the like as the control device 200. In the present disclosure, the storage 223 stores, for example, the first data corresponding to the coordinates of the touch detection position extracted by the coordinate extractor 212.

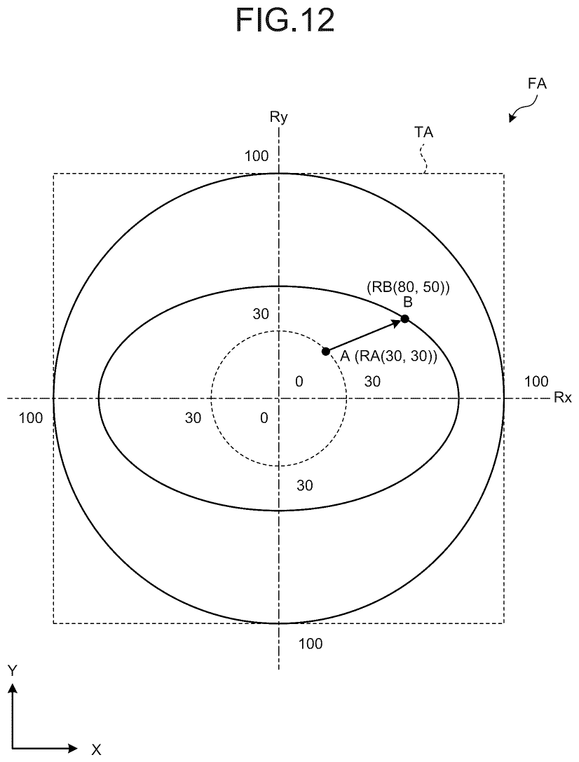

A method of adjusting the first data at the illumination device 1 in the above-described configuration according to the first embodiment will be described below. FIG. 12 is a conceptual diagram illustrating an example of the method of adjusting the first data in the first embodiment.

As illustrated in FIG. 12, a data adjustment region TA is provided in the detection region FA of the touch sensor 30. The horizontal axis of the data adjustment region TA represents a coordinate axis in the X direction (first direction) and corresponds to the Dx direction of the illumination device 1. The vertical axis of the data adjustment region TA represents a coordinate axis in the Y direction (second direction) and corresponds to the Dy direction of the illumination device 1. The data adjustment region TA only needs to be provided in the detection region FA of the touch sensor 30 and may be the entire detection region FA.

In the present embodiment, the first data in the X direction and the first data in the Y direction are discrete values obtained by normalizing information on the light distribution angle that is controlled in the illumination device 1. Specifically, in the present embodiment, the first data generator 221 generates first data R(Rx, Ry) by using information on the light distribution angle to be controlled at the illumination device 1 as a parameter of control of the control device 200. Hereinafter, the first data R(Rx, Ry) generated by the first data generator 221 in the present embodiment is also referred to as “first light distribution angle information”.

The first data Rx in the X direction and the first data Ry in the Y direction are defined to be values corresponding to the coordinates of the touch detection position detected in the data adjustment region TA. In the example illustrated in FIG. 12, the first data Rx in the X direction and the first data Ry in the Y direction each can be a value of “0” to “100”. The circle illustrated with a dashed line in FIG. 12 indicates the locus of the coordinates of a position where the first data Rx in the X direction is “30” and the first data Ry in the Y direction is “30”, the circle illustrated with a solid line indicates the locus of the coordinates of a position where the first data Rx in the X direction is “100” and the first data Ry in the Y direction is “100”, and the ellipse illustrated with a solid line indicates the locus of the coordinates of a position where the first data Rx in the X direction is “80” and the first data Ry om the Y direction is “50”.

In the example illustrated in FIG. 12, the coordinates of the touch detection position obtained by the coordinate extractor 212 are moved from a position A to a position B in the data adjustment region TA. In this case, the first data generator 221 generates the first data R(Rx, Ry) in accordance with the coordinates (x, y) of the touch detection position, which is output from the coordinate extractor 212 on a time-series basis while the coordinates of the touch detection position move from the position A to the position B in the data adjustment region TA. Specifically, the relation between change ΔR(ΔRx, ΔRy) of the first data R(Rx, Ry) by one step and change (Δx, Δy) of the coordinates (x, y) of the touch detection position by one step is expressed by Expressions (1) and (2) below. In the expressions, k is a coefficient determined by the number of detection elements 31 in the data adjustment region TA.

$$Δ Rx = k \times Δ x \qquad ( 1 )$$

$$Δ Ry = k \times Δ y \qquad ( 2 )$$

Specifically, in a case of k=4, for example, the first data changes by one step when the coordinates of the touch detection position moves by four. In other words, the change amount of the first data R(Rx, Ry) is proportional to the movement amount of the coordinates (x, y) of the touch detection position.

The control device 200 sequentially transmits the first data R(Rx, Ry) generated by the first data generator 221 to the illumination device 1.

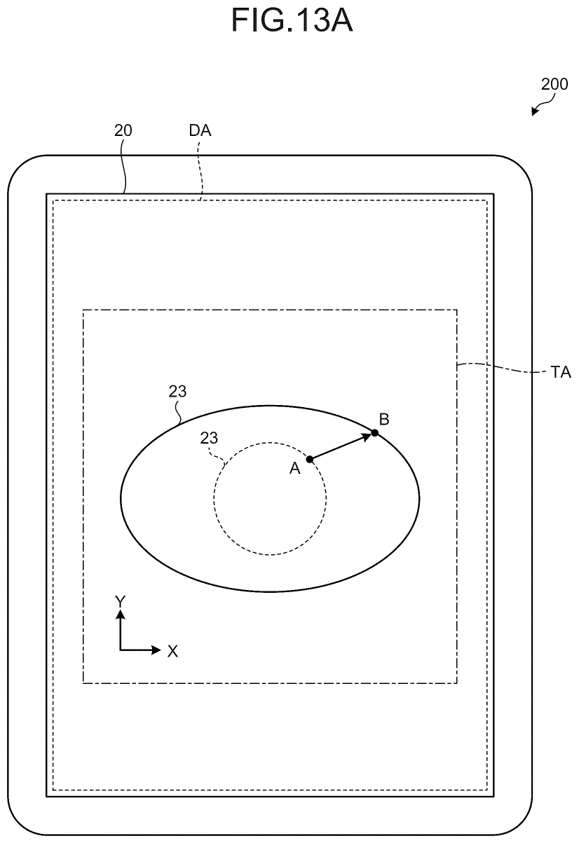

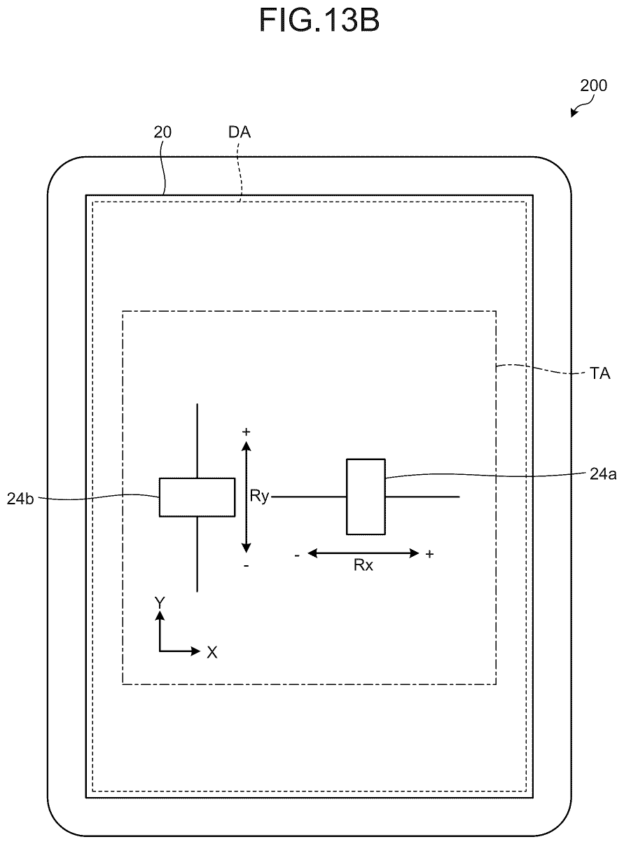

FIG. 13A is a conceptual diagram illustrating a first display example of the control device according to the first embodiment for adjusting the first data. FIG. 13B is a conceptual diagram illustrating a second display example of the control device according to the first embodiment for adjusting the first data.

A display region DA that overlaps the detection region FA of the touch sensor 30 illustrated in FIG. 9 in plan view is provided on the display panel 20.

In the aspect illustrated in FIG. 13A, the locus of the coordinates of the position corresponding to the first data R(Rx, Ry) on the data adjustment region TA is displayed as a schematic shape image 23 of the irradiation area. In this first display example, the first data Rx in the X direction and the first data Ry in the Y direction are simultaneously adjusted by, for example, tapping the position A on the schematic shape image 23 of the irradiation area and swiping from the position A to the position B.

In the aspect illustrated in FIG. 13B, a slide bar 24a for adjusting the first data Rx in the X direction and a slide bar 24b for adjusting the first data Ry in the Y direction are displayed on the data adjustment region TA. In this second display example, the first data Rx is adjusted by tapping the slide bar 24a and swiping in the X direction, and the first data Ry is adjusted by tapping the slide bar 24b and swiping in the Y direction.

The example of adjusting the first data is not limited to the above-described examples, and the control device 200 may be provided with physical sliders.

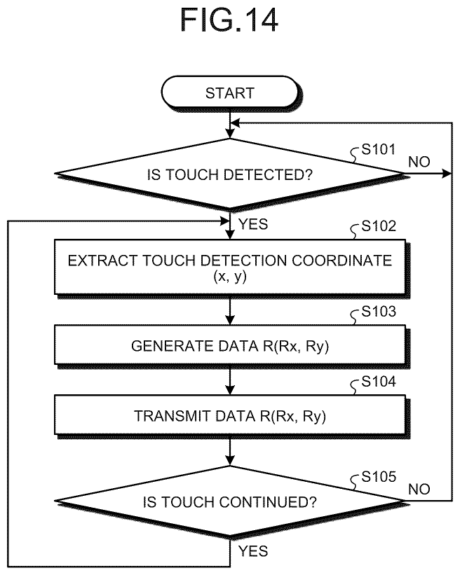

FIG. 14 is a flowchart illustrating an example of first data generation processing by the control device according to the first embodiment.

The detector 211 detects existence of a touch in the data adjustment region TA of the touch sensor 30 (step S101).

In a case where a touch is detected in the data adjustment region TA (Yes at step S101), the coordinate extractor 212 extracts the coordinates (x, y) of the touch detection position (step S102).

The first data generator 221 generates the first data R(Rx, Ry) corresponding to the coordinates (x, y) of the touch detection position (step S103). Specifically, the first data generator 221 reads, from the storage 223, the first data R(Rx, Ry) corresponding to the coordinates (x, y) of the touch detection position extracted by the coordinate extractor 212.

The control device 200 transmits the first data R(Rx, Ry) generated by the first data generator 221 to the illumination device 1 through the communication means 300 (step S104).

The detector 211 detects whether the touch is continued in the data adjustment region TA of the touch sensor 30 (step S105).

In a case where no touch is detected at step S101 (No at step S101) or in a case where the touch is not continued at step S105 (No at step S105), the process returns to the processing at step S101 to execute the same processing.

In a case where the touch is continued in the data adjustment region TA of the touch sensor 30 (Yes at step S105), the process returns to the processing at step S102 to re-execute the processing starting from step S102.

The illumination device 1 changes the light distribution angle in each of the Dx and Dy directions in accordance with the first data R(Rx, Ry) transmitted from the control device 200. The configuration and operation of the illumination device according to the first embodiment for controlling the light distribution angle will be described below.

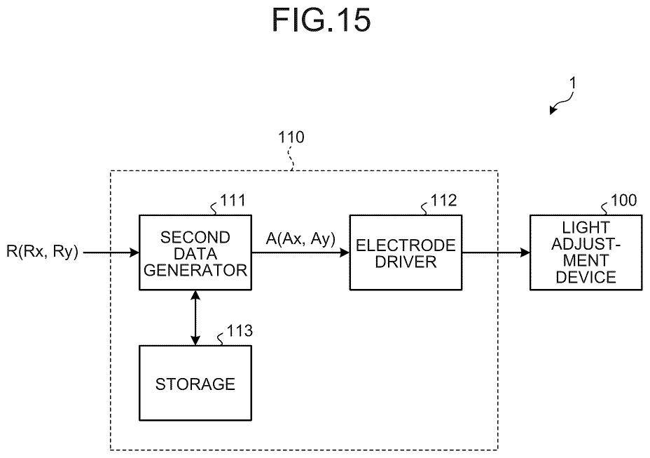

FIG. 15 is a diagram illustrating an example of a control block configuration that controls the light adjustment device in the illumination device according to the first embodiment.

As illustrated in FIG. 15, a controller 110 of the illumination device 1 according to the first embodiment includes a second data generator 111, an electrode driver 112, and a storage 113.

The second data generator 111 generates second data Ax in the Dx direction and second data Ay in the Dy direction for the illumination device 1 based on the first light distribution angle information (first data R(Rx, Ry)) received from the control device 200.

In the present embodiment, the second data Ax in the Dx direction and the second data Ay in the Dy direction, which are generated by the second data generator 111, are discrete values obtained by normalizing information on the light distribution angle that is controlled in the illumination device 1. Hereinafter, second data A(Ax, Ay) generated by the second data generator 111 in the present embodiment is also referred to as “second light distribution angle information”.

The electrode driver 112 supplies drive voltage to the drive electrodes 10 and 13 of the first liquid crystal cell 2 and the second liquid crystal cell 3 of the light adjustment device 100 based on the second light distribution angle information (second data A(Ax, Ay)) generated by the second data generator 111.

In the present embodiment, the storage 113 stores a look-up table indicating a correspondence relation between the first data R(Rx, Ry) and the second data A(Ax, Ay). The second data generator 111 refers to the look-up table stored in the storage 113, reads the second data A(Ax, Ay) corresponding to the first data R(Rx, Ry) received from the control device 200, and outputs the read second data A(Ax, Ay) as the second light distribution angle information to the electrode driver 112.

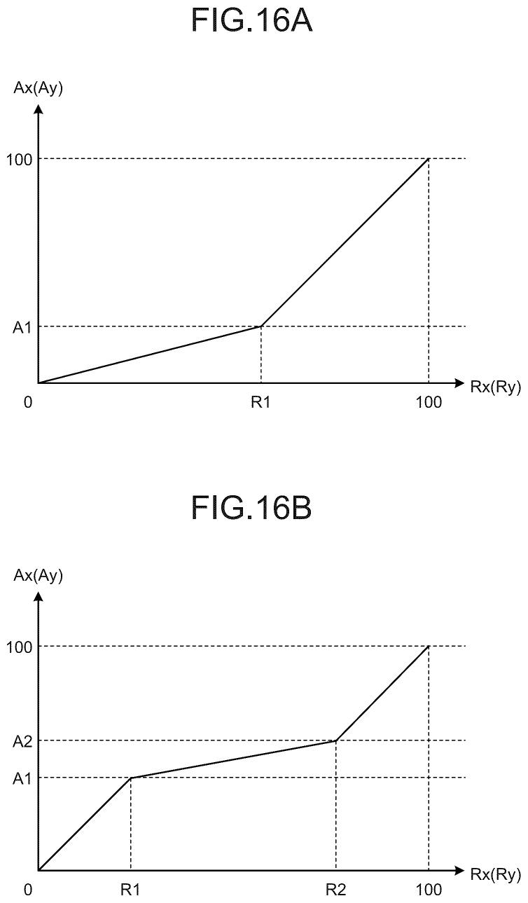

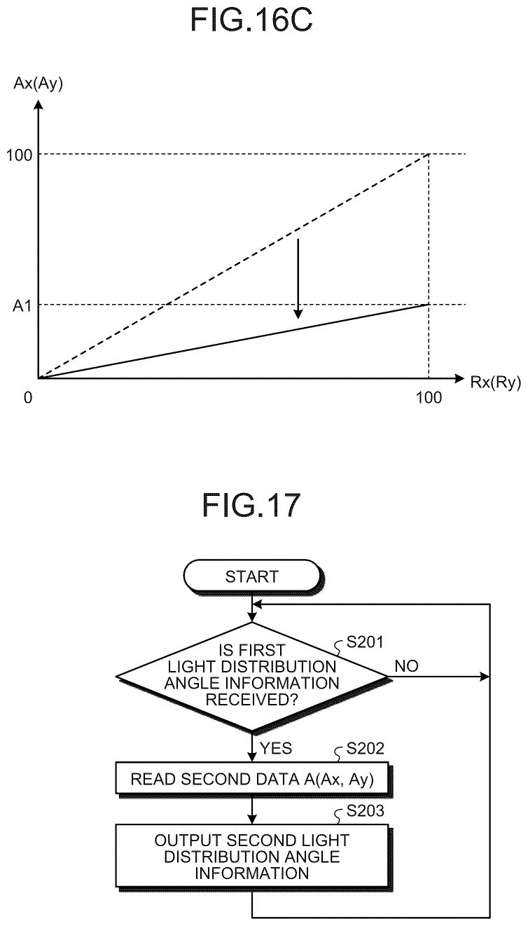

FIG. 16A is a line diagram illustrating a first example of the look-up table indicating the correspondence relation between the first data and the second data. FIG. 16B is a line diagram illustrating a second example of the look-up table indicating the correspondence relation between the first data and the second data. FIG. 16C is a line diagram illustrating a third example of the look-up table indicating the correspondence relation between the first data and the second data.

In FIGS. 16A, 16B, and 16C, the horizontal axis represents the first data R(Rx, Ry) and the vertical axis represents the second data A(Ax, Ay). In the examples illustrated in FIGS. 16A, 16B, and 16C, the second data Ax in the Dx direction and the second data Ay in the Dy direction each can be a value of “0” to “100”. The maximum value (100) of the second data Ax in the Dx direction and the second data Ay in the Dy direction corresponds to the maximum value of a control range of the light distribution angle of the illumination device 1 (light adjustment device 100). The dashed line illustrated in FIG. 16C corresponds to an example in which the correspondence relation between the first data R(Rx, Ry) and the second data A(Ax, Ay) is linear and the second data A(Ax, Ay) is the maximum value (100) at the maximum value (100) of the first data R(Rx, Ry).

In the look-up table illustrated in FIG. 16A, the gradient of the second data A(Ax, Ay) with respect to the first data R(Rx, Ry) is different between the range of the first data R(Rx, Ry) smaller than R1 and the range thereof equal to or larger than R1. Specifically, the gradient of the second data A(Ax, Ay) with respect to the first data R(Rx, Ry) in the range of the first data R(Rx, Ry) smaller than R1 is smaller than the gradient of the second data A(Ax, Ay) with respect to the first data R(Rx, Ry) in the range of the first data R(Rx, Ry) equal to or larger than R1.

In a case where the look-up table illustrated in FIG. 16A is used, the light distribution angle can be more highly accurately controlled in the range of the second light distribution angle information (second data A(Ax, Ay)) from 0 to A1, which corresponds to the range of the first data R(Rx, Ry) from 0 to R1, than in the other range (the range of the second data A(Ax, Ay) from A1 to 100, which corresponds to the range of the first data R(Rx, Ry) from R1 to 100). In other words, in the range of the first data R(Rx, Ry) from 0 to R1, the irradiation area of the illumination device 1 can be highly accurately adjusted in accordance with the change amount of the touch detection position in the data adjustment region TA of the control device 200.

In the look-up table illustrated in FIG. 16B, the gradient of the second data A(Ax, Ay) with respect to the first data R(Rx, Ry) is different between the range of the first data R(Rx, Ry) equal to or larger than R1 and smaller than R2 and each of the range of the first data R(Rx, Ry) smaller than R1 and the range thereof equal to or larger than R2. Specifically, the gradient of the second data A(Ax, Ay) with respect to the first data R(Rx, Ry) in the range of the first data R(Rx, Ry) equal to or larger than R1 and smaller than R2 is smaller than the gradient of the second data A(Ax, Ay) with respect to the first data R(Rx, Ry) in the range of the first data R(Rx, Ry) smaller than R1 and the range thereof equal to or larger than R2.

In a case where the look-up table illustrated in FIG. 16B is used, light distribution angle can be more highly accurately controlled in the range of the second data A(Ax, Ay) from A1 to A2, which corresponds to the range of the first data R(Rx, Ry) from R1 to R2, than in the other range (the range of the second data A(Ax, Ay) from 0 to A1, which corresponds to the range of the first data R(Rx, Ry) from 0 to R1, and the range of the second data A(Ax, Ay) from A2 to 100, which corresponds to the range of the first data R(Rx, Ry) from R2 to 100). In other words, in the range of the first data R(Rx, Ry) from R1 to R2, the irradiation area of the illumination device 1 can be highly accurately adjusted in accordance with the change amount of the touch detection position in the data adjustment region TA of the control device 200.

In the look-up table illustrated in FIG. 16C, the gradient of the second data A(Ax, Ay) with respect to the first data R(Rx, Ry) is constant in the entire range of the first data R(Rx, Ry). In other words, the second data A(Ax, Ay) linearly increases with the increase of the first data R(Rx, Ry) in the entire range of the first data R(Rx, Ry). The maximum value A1 of the second data A(Ax, Ay) is smaller than the maximum value of the control range of the light distribution angle of the illumination device 1 (light adjustment device 100).

In a case where the look-up table illustrated in FIG. 16C is used, the light distribution angle can be more highly accurately controlled in the entire range of the second data A(Ax, Ay), which corresponds to the entire range of the first data R(Rx, Ry), than in the example illustrated with the dashed line. In other words, in the entire range of the first data R(Rx, Ry), the irradiation area of the illumination device 1 can be more highly accurately adjusted in accordance with the change amount of the touch detection position in the data adjustment region TA of the control device 200 than in the example illustrated with the dashed line.

The look-up tables stored in the storage 113 are not limited to the examples illustrated in FIGS. 16A, 16B, and 16C. For example, the look-up table illustrated in FIG. 16A and the look-up table illustrated in FIG. 16C may be combined, or the look-up table illustrated in FIG. 16B and the look-up table illustrated in FIG. 16C may be combined.

In the aspects exemplarily illustrated in FIGS. 16A and 16B, the second data A(Ax, Ay) linearly increases with the increase of the first data R(Rx, Ry) except for inflection points, but the second data A(Ax, Ay) may increase in a curved shape including inflection points. In the aspect exemplarily illustrated in FIG. 16C, the correspondence relation between the first data R(Rx, Ry) and the second data A(Ax, Ay) is linear in the entire range, but the increase rate of the second data A(Ax, Ay) may increase along with the increase of the first data R(Rx, Ry) or the increase rate of the second data A(Ax, Ay) may decrease along with the increase of the first data R(Rx, Ry).

Correspondence information indicating the correspondence relation between the first data R(Rx, Ry) and the second data A(Ax, Ay) is not limited to the look-up tables as illustrated in FIGS. 16A, 16B, and 16C. The storage 113, for example, may store a function that defines the correspondence relation between the first data R(Rx, Ry) and the second data A(Ax, Ay) or may store the second data A(Ax, Ay) corresponding to the first data R(Rx, Ry) as data.

FIG. 17 is a flowchart illustrating an example of light distribution angle control processing by the illumination device according to the first embodiment.

The second data generator 111 determines whether the first light distribution angle information is received from the control device 200 (step S201).

In a case where the first light distribution angle information is not received at step S201 (No at step S201), the processing at step S201 is re-executed.

In a case where the first light distribution angle information is received (Yes at step S201), the second data generator 111 reads the second data A(Ax, Ay) corresponding to the first data R(Rx, Ry) from the storage 113 (step S202) and outputs the read second data A(Ax, Ay) as the second light distribution angle information to the electrode driver 112 (step S203), and then the process returns to the processing at step S201.

As described above, the illumination device 1 according to the present embodiment holds correspondence information indicating the correspondence relation between the first data R(Rx, Ry) transmitted from the control device 200 and the second data A(Ax, Ay) used to control the light adjustment device 100, generates the second data A(Ax, Ay) by adjusting the first data R(Rx, Ry) based on the correspondence information, and supplies drive voltage to the drive electrodes 10 and 13 of the first liquid crystal cell 2 and the second liquid crystal cell 3 of the light adjustment device 100.

This makes it possible to freely set a range in which the accuracy of adjustment of the light irradiation area is to be improved in the control device 200, and thus the illumination device 1 that is highly convenient is obtained.

### Second Embodiment

Although the first embodiment describes an example in which information on the light distribution angle that is controlled in the illumination device 1 is used as a parameter of control by the control device 200 to generate the first data R(Rx, Ry), a second embodiment will describe an example in which information on the light irradiation area of the illumination device 1 is used as the parameter of control by the control device 200.

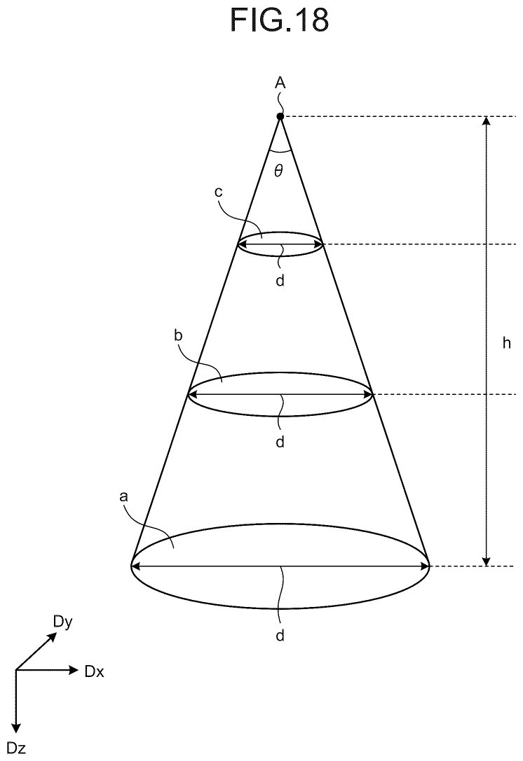

FIG. 18 is a schematic diagram illustrating the relation between the light distribution angle and the light irradiation area controlled by the illumination device according to the second embodiment. In FIG. 18, the illumination device 1 is assumed to be a point light source A, and a light irradiation area d on each of imaginary planes “a”, “b”, and “c” orthogonal to the Dz direction is illustrated.

As illustrated in FIG. 18, the light irradiation area d (beam diameter determined by the light distribution angle θ) varies depending on a distance h from the illumination device 1, but the light distribution angle θ remains the same. The light distribution angle θ in this case is expressed by Expression (3) below.

$$θ = 2 \times arctan ( d / 2 ) / h \qquad ( 3 )$$

In the present embodiment, the first data in the X direction and the first data in the Y direction are discrete values obtained by normalizing irradiation area information determined based on the distance from the illumination device 1 to a light irradiation target object. In other words, in the present embodiment, the first data generator 221 generates the first data R(Rx, Ry) by using, as a parameter of control by the control device 200, the irradiation area information determined based on the distance from the illumination device 1 to the light irradiation target object. Hereinafter, the first data R(Rx, Ry) generated by the first data generator 221 in the present embodiment is also referred to as “irradiation area information”. In addition, the second data A(Ax, Ay) generated by the second data generator 111 in the present embodiment is also referred to as “light distribution angle information”.

In the present embodiment, the second data generator 111 generates the second data Ax in the Dx direction and the second data Ay in the Dy direction for the illumination device 1 based on the illumination area information (the first data R(Rx, Ry)) received from the control device 200. Look-up tables applied in the present embodiment may be obtained by reflecting Expression (3) described above onto the look-up tables illustrated in FIGS. 16A, 16B, and 16C described above in the first embodiment.

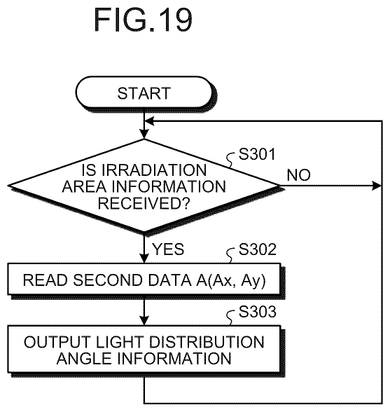

FIG. 19 is a flowchart illustrating an example of light distribution angle control processing by the illumination device according to the second embodiment.

The second data generator 111 determines whether the irradiation area information is received from the control device 200 (step S301).

In a case where the irradiation area information is not received at step S301 (No at step S301), the processing at step S301 is re-executed.

In a case where the irradiation area information is received (Yes at step S301), the second data generator 111 reads the second data A(Ax, Ay) corresponding to the first data R(Rx, Ry) from the storage 113 (step S302) and outputs the read second data A(Ax, Ay) as the light distribution angle information to the electrode driver 112 (step S303), and then the process returns to the processing at step S301.

In the present embodiment, as in the first embodiment, correspondence information indicating the correspondence relation between the first data R(Rx, Ry) transmitted from the control device 200 and the second data A(Ax, Ay) used to control the light adjustment device 100 is held, the second data A(Ax, Ay) is generated by adjusting the first data R(Rx, Ry) based on the correspondence information, and drive voltage is supplied to the drive electrodes 10 and 13 of the first liquid crystal cell 2 and the second liquid crystal cell 3 of the light adjustment device 100.

This makes it possible to freely set a range in which the accuracy of adjustment of the light irradiation area is to be improved in the control device 200, and thus the illumination device 1 that is highly convenient is obtained.

### Third Embodiment

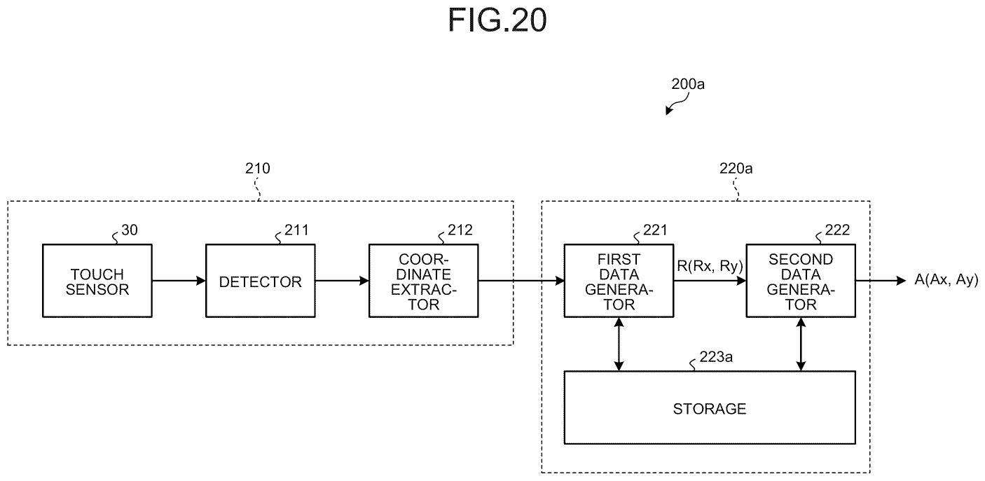

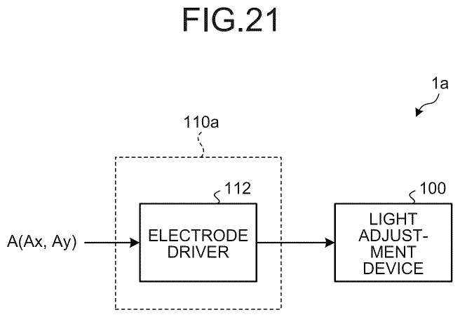

FIG. 20 is a diagram illustrating an example of a control block configuration that adjusts the second data to be transmitted to the illumination device in the control device according to a third embodiment. FIG. 21 is a diagram illustrating an example of a control block configuration that controls the light adjustment device in the illumination device according to the third embodiment.

In the third embodiment, a processing device 220a of a control device 200a according to the third embodiment includes, in addition to the configuration of the first and second embodiments, a second data generator 222 corresponding to the second data generator 111 provided in the controller 110 of the illumination device 1 in the first and second embodiments.

In the present embodiment, a storage 223a stores a look-up table indicating the correspondence relation between the first data R(Rx, Ry) and the second data A(Ax, Ay). The second data generator 222 refers to the look-up table stored in the storage 223a, reads the second data A(Ax, Ay) corresponding to the first data R(Rx, Ry) generated by the first data generator 221, and transmits the read second data A(Ax, Ay) to an illumination device 1a.

The first data R(Rx, Ry) may be discrete values obtained by normalizing information on the light distribution angle that is controlled in the illumination device 1 as in the first embodiment or may be discrete values obtained by normalizing irradiation area information determined based on the distance from the illumination device 1 to the light irradiation target object as in the second embodiment.

The control device 200a according to the present embodiment holds correspondence information indicating the correspondence relation between the first data R(Rx, Ry) generated by the first data generator 221 and the second data A(Ax, Ay) used to control the light adjustment device 100, generates the second data A(Ax, Ay) by adjusting the first data R(Rx, Ry) based on the correspondence information, and transmits the second data A(Ax, Ay) to the illumination device 1a. A controller 110a of the illumination device 1a supplies drive voltage to the drive electrodes 10 and 13 of the first liquid crystal cell 2 and the second liquid crystal cell 3 of the light adjustment device 100 based on the second data A(Ax, Ay) transmitted from the control device 200a.

This makes it possible to freely set a range in which the accuracy of adjustment of the light irradiation area is to be improved in the control device 200a, and thus the illumination device 1a that is highly convenient is obtained.

The preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

What is claimed is:

1. An illumination device comprising:
a light source;
a light adjustment device configured to control a light distribution angle of light emitted from the light source; and
a controller configured to control the light adjustment device, wherein
the controller includes
a storage configured to hold correspondence information indicating a correspondence relation between first data that is input from a control device and second data that is used to control the light distribution angle,
a data generator configured to generate second data by adjusting the first data based on the correspondence information, and
a driver configured to drive the light adjustment device based on the second data.

2. The illumination device according to claim 1, wherein a rate of increase of the second data with respect to an increase of the first data is different between a range of the first data smaller than a predetermined value and a range of the first data equal to or larger than the predetermined value.

3. The illumination device according to claim 1, wherein a light distribution angle controlled by the light adjustment device based on a maximum value of the second data is smaller than a maximum value of a control range of the light distribution angle of the light adjustment device.

4. The illumination device according to claim 1, wherein the first data is a discrete value obtained by normalizing information on the light distribution angle of the light adjustment device.

5. The illumination device according to claim 1, wherein the first data is a discrete value obtained by normalizing irradiation area information determined based on a distance to an irradiation target object.

6. An illumination control system comprising an illumination device and a control device, the illumination device being capable of controlling a light distribution angle of light emitted from a light source, the control device being configured to control the illumination device, wherein
the control device includes
a touch sensor,
a detector configured to extract a touch detection position on the touch sensor, and
a first data generator configured to generate first data in accordance with the touch detection position,
the illumination device includes
a light adjustment device configured to control the light distribution angle, and
a controller configured to control the light adjustment device, and
the controller includes
a storage configured to hold correspondence information indicating a correspondence relation between the first data and second data that is used to control the light distribution angle,
a second data generator configured to generate second data by adjusting the first data based on the correspondence information, and
a driver configured to drive the light adjustment device based on the second data.

7. The illumination control system according to claim 6, wherein a rate of increase of the second data with respect to an increase of the first data is different between a range of the first data smaller than a predetermined value and a range of the first data equal to or larger than the predetermined value.

8. The illumination control system according to claim 6, wherein a light distribution angle controlled by the light adjustment device based on a maximum value of the second data is smaller than a maximum value of a control range of the light distribution angle of the light adjustment device.

9. The illumination control system according to claim 6, wherein the first data is a discrete value obtained by normalizing information on the light distribution angle of the light adjustment device.

10. The illumination control system according to claim 6, wherein the first data is a discrete value obtained by normalizing irradiation area information determined based on a distance to an irradiation target object.

11. An illumination control system comprising an illumination device and a control device, the illumination device being capable of controlling a light distribution angle of light emitted from a light source, the control device being configured to control the illumination device, wherein
the control device includes
a touch sensor,
a detector configured to extract a touch detection position on the touch sensor,
a first data generator configured to generate first data in accordance with the touch detection position,
a storage configured to hold correspondence information indicating a correspondence relation between the first data and second data that is used to control the light distribution angle, and
a second data generator configured to generate second data by adjusting the first data based on the correspondence information,
the illumination device includes
a light adjustment device configured to control the light distribution angle, and
a controller configured to control the light adjustment device, and
the controller includes a driver configured to drive the light adjustment device based on the second data.

12. The illumination control system according to claim 11, wherein a rate of increase of the second data with respect to an increase of the first data is different between a range of the first data smaller than a predetermined value and a range of the first data equal to or larger than the predetermined value.

13. The illumination control system according to claim 11, wherein a light distribution angle controlled by the light adjustment device based on a maximum value of the second data is smaller than a maximum value of a control range of the light distribution angle of the light adjustment device.

14. The illumination control system according to claim 11, wherein the first data is a discrete value obtained by normalizing information on the light distribution angle of the light adjustment device.

15. The illumination control system according to claim 11, wherein the first data is a discrete value obtained by normalizing irradiation area information determined based on a distance to an irradiation target object.
